(19) United States
(12) Patent Application Publication
(10) Pub. No.: US 2006/0010649 A1
(43) Pub. Date: Jan. 19, 2006

(54) Hinge assembly for media player

(75) Inventors: Xiang-Hui Zhang, Shenzhen (CN); Huang-Chin Liao, Tucheng (TW); Wen-Jie Bao, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/181,308

(22) Filed: Jul. 14, 2005

(30) Foreign Application Priority Data
Jul. 17, 2004 (CN) 200420071821.6

(51) Int. Cl. E05C 17/64

(52) U.S. Cl. 16/340

(57) ABSTRACT

A hinge assembly for a media player having a main body and a cover body, includes a first hinge subassembly. The first hinge subassembly includes a first base plate adapted to be secured to the main body of the media player, a first joint axle secured to the first base plate, a first hinge arm adapted to be secured to the cover of the media player, several resilient bushings surrounding the first joint axle and arranged adjacent the first end of the first hinge arm, and an adjustable fastener coupled to the first joint axle for exerting an adjustable force applied to the first end of the first hinge arm. The first hinge arm has a first end pivotally coupled to the first joint axle. The adjustable fastener is positioned to generate a friction force between the first end of the first hinge arm and the at least one resilient bushing, and the friction force is sufficient to overcome gravitational force acting on the cover of the media player.

### BACKGROUND

1. Field of the Invention

The present invention generally relates to hinge assemblies, and particularly to a hinge assembly for a media player such as an optical disk player.

2. Related Art

Media players are apparatuses for reproducing and/or recording electronic data from and/or onto various storage media. A media player usually comprises a main body and a cover body having a display screen. Electronic modules contained in the main body are for reproduction and/or recording of the data. The display screen of the cover body is for providing information or graphics thereon, such as system information of the media player, reproduced information, and so on. Generally, a hinge device is provided in the media player for pivotally attaching the display screen to the main body, and being able to adjust the display screen to a desired position for viewing.

Conventional hinge devices include a stationary piece, a movable piece, and a shaft interconnecting the stationary and movable pieces. The stationary and movable pieces are secured to the shaft, and are rotatable relative to each other. The movable piece is generally held and maintained at a predetermined position by an elastic force, a friction force, a torsion force, or the like. However, most hinge devices are not adjustable once assembled. That is, a retaining force applied to the movable piece is constant, once the hinge device is assembled. As the movable piece is generally fixed to (for example) a cover body to adjust the position of the cover body, the hinge device has to be capable of sustaining the weight of the cover body at any possible position. This means that any one conventional hinge device is only suited for media players with covers having a similar weight. When a media player has a cover with a different weight, another hinge device compatible with the cover needs to be obtained.

Therefore, a heretofore unaddressed need exists in the industry to address the aforementioned deficiencies and inadequacies.

### SUMMARY

Briefly described, one embodiment of a hinge assembly for a media player, among others, can be implemented as described herein.

The hinge assembly for a media player having a main body and a cover, comprises a first hinge subassembly. The first hinge subassembly comprises a first base plate adapted to be secured to the main body of the media player, a first joint axle secured to the first base plate, a first hinge arm adapted to be secured to the cover of the media player, at least one resilient bushing surrounding the first joint axle and arranged adjacent the first end of the first hinge arm, and an adjustable fastener coupled to the first joint axle for exerting an adjustable force applied to the first end of the first hinge arm. The first hinge arm has a first end pivotally coupled to the first joint axle. The adjustable fastener is positioned to generate a friction force between the first end of the first hinge arm and the at least one resilient bushing, and the friction force is sufficient to overcome gravitational force acting on the cover of the media player.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is an exploded, isometric view of a media player with a hinge assembly according to an embodiment of the present invention.

FIG. 2 is an enlarged, exploded, isometric view of a first hinge subassembly of FIG. 1.

FIG. 3 is an enlarged, exploded, isometric view of a second hinge subassembly of FIG. 1.

### DETAILED DESCRIPTION OF PREFERRED EMBODIMENTS

Reference will now be made to the drawing figures to describe the preferred embodiments of the present invention in detail.

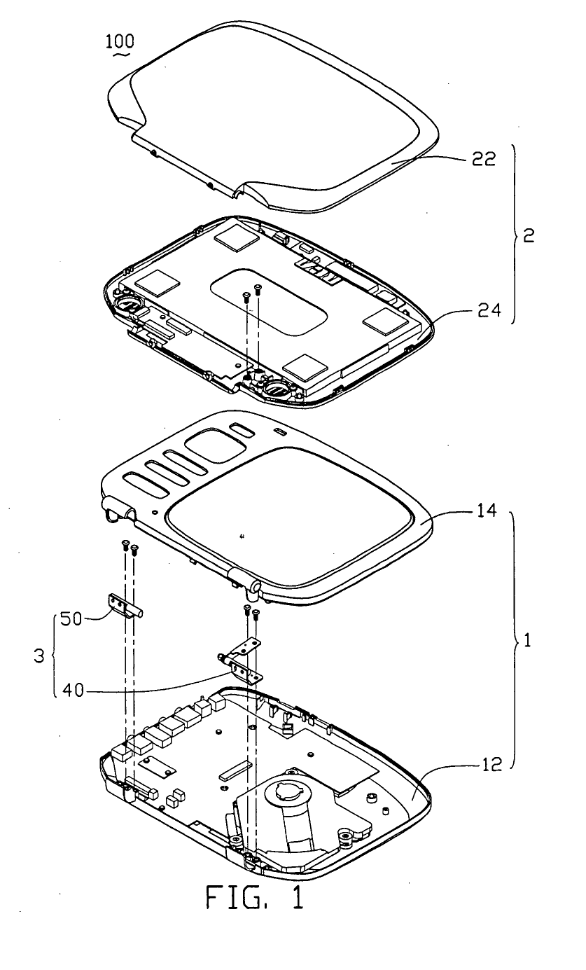

Referring to FIG. 1, a media player 100 with a hinge assembly 3 is shown. The media player 100 is a portable disk player, and comprises a main body 1 and a cover body 2 pivotally mounted to the main body 1 by the hinge assembly 3. The main body 1 includes a lower portion 12, and an upper portion 14 attached to the lower portion 12. The lower portion 12 and the upper portion 14 cooperatively form a space for receiving a reproduction and/or recording module (not labeled) therein. The cover body 2 includes an exterior cover shell 22, and an interior cover shell 24 coupled to the exterior cover shell 22. The exterior and interior cover shells 22 and 24 cooperatively form a space for receiving a liquid crystal display (not labeled) therein.

The hinge assembly 3 includes a first hinge subassembly 40 and a second hinge subassembly 50 coaxially disposed around rear edges of the main body 1 and the cover body 2, for pivotally attaching the cover body 2 to the main body 1 and allowing the cover body 2 to be stationed at any desired angle relative to the main body 1. The first hinge subassembly 40 is secured to both the main body 1 and the cover body 2, while the second hinge subassembly 50 is secured to the main body 1.

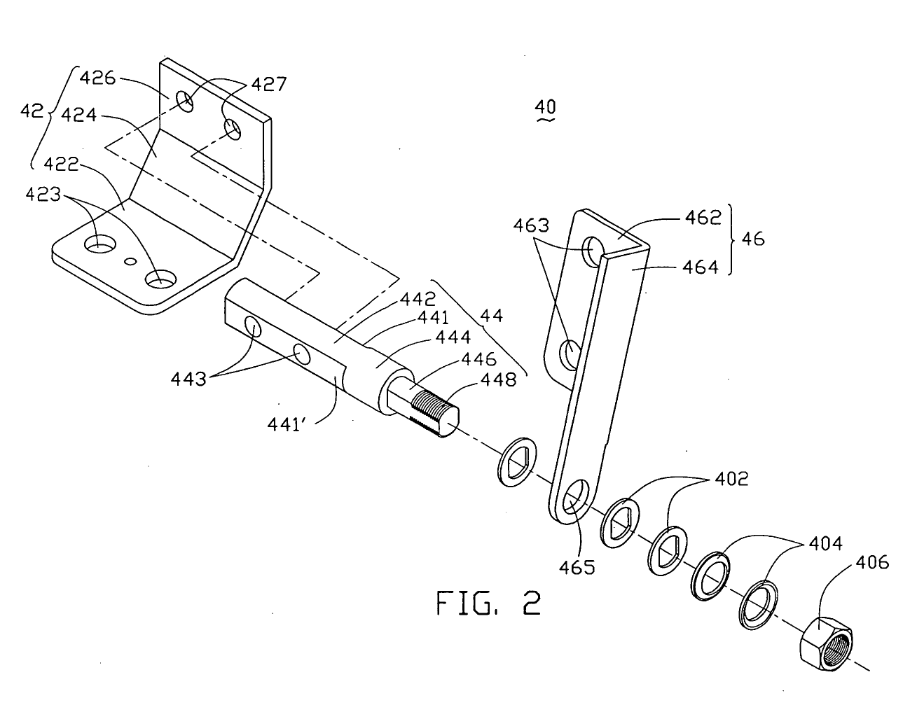

Now referring to FIG. 2, an exploded view of the first hinge subassembly 40 is illustrated. The first hinge subassembly 40 includes a first base plate 42, a first joint axle 44, and a first hinge arm 46. The first joint axle 44 is secured to the first base plate 42 by a pair of rivets (not shown), and the first hinge aim 46 is pivotally coupled to the first joint axle 44.

The first base plate 42 mainly includes a first base portion 422 with a pair of first mounting holes 423 defined therein, a first riveting portion 426 substantially perpendicular to the first base portion 422, and a first intermediate portion 424 interconnecting the first base portion 422 and the first riveting portion 426. A pair of first riveting holes 427 is defined in the first riveting portion 426. The first mounting holes 423 of the first base portion 422 are adapted for the securing of the first base plate 42 to the main body 1 of the media player 100 by fasteners such as screw bolts.

The first joint axle 44 includes a fastening portion 442, a columnar portion 444, a pivot portion 446, and a threaded portion 448. A pair of first opposite flat faces 441, 441′ is formed on the fastening portion 442, and a pair of first matching holes 443 is defined in the fastening portion 4. The first flat face 441 abuts against a side surface (not labeled) of the first riveting portion 426. The first matching holes 443 are aligned with the first riveting holes 427 for extension of a pair of rivets (not shown) therethrough, thereby securing the first joint axle 44 to the first base plate 42. The pivot portion 446 has a smaller diameter than the columnar portion 444. The pivot portion 446 has two opposite flat side surfaces (not labeled). The threaded portion 448 extends from the pivot portion 446, and has a thread defined on an outer surface thereof. The columnar portion 444 is received in a space constructed between two semicircular notches (not labeled) defined at an end of the rear edge of the exterior cover shell 22 and the interior cover shell 24 of the cover body 2 (as shown in FIG. 1). Thus, the cover body 2 is rotatable around the first joint axle 44 of the first hinge assembly 40.

The first hinge arm 46 includes two substantially perpendicular portions; i.e., a cover-mounting portion 462 and a rotating portion 464. A pair of fixing holes 463 is defined in the cover-mounting portion 462, for securing of the first hinge arm 46 to the cover body 2 of the media player 100. A fitting hole 465 is defined at a first end of the first hinge arm 46. The fitting hole 465 has a slightly larger diameter than the pivot portion 446 of the first joint axle 44. The first joint axle 44 extends through one or more plain washers 402, the fitting hole 465, and a plurality of resilient bushings 404 in that order. Each plain washer 402 has a through hole (not labeled) configured according to the profile of the flat portion 446 of the first joint axle 44, so that the plain washers 402 cannot rotate relative to the first joint axle 44. The resilient bushings 404 are for being springably engaged between the plain washers 402 and a nut 406. The resilient bushings 404 may, for example, be disk-shaped spring washers. The nut 406 is coupled to the first joint axle 44 for exerting an adjustable force applied to the first end of the first hinge arm 46. With this configuration, a friction force can be generated between the first end of the first hinge arm 46 and the plain washers 402, with the friction force being sufficient to overcome gravitational force acting on the cover body 2.

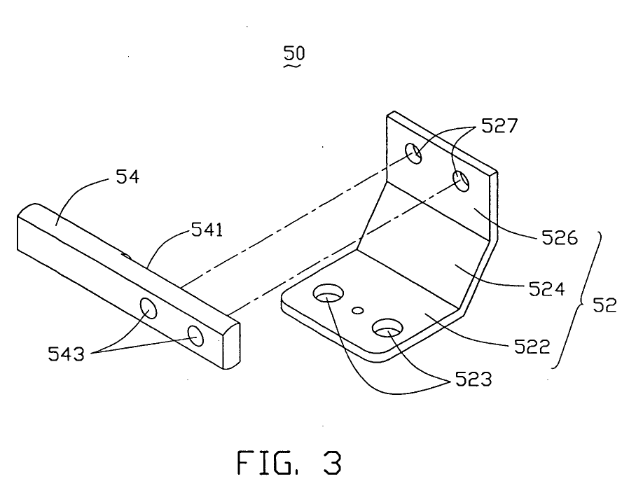

Now referring to FIG. 3, an exploded view of the second hinge subassembly 50 is illustrated. The second hinge subassembly 50 includes a second base plate 52, and a second joint axle 54 secured to the second base plate 52.

Similar to the first base plate 42, the second base plate 52 mainly includes a second base portion 522 with a pair of second mounting holes 523 therein, a second riveting portion 526 substantially perpendicular to the second base portion 522, and a second intermediate portion 524 interconnecting the second base portion 522 and the second riveting portion 526. A pair of second riveting holes 527 is defined in the second riveting portion 526. The second mounting holes 523 of the second base portion 522 are adapted for the securing of the second base plate 52 to the main body 1 of the media player 100 by fasteners such as screw bolts.

The second joint axle 54 has a second flat face 541. A pair of second matching holes 543 is defined in the vicinity of one end of the second joint axle 54. The second flat face 541 abuts against a side surface (not labeled) of the second riveting portion 526. The second matching holes 543 are aligned with the second riveting holes 527 for extension of a pair of rivets (not shown) therethrough, thereby securing the second joint axle 54 to the second base plate 52. The other end of the second joint axle 54 is received in a space constructed between two semicircular notches (not labeled) defined at the other end of the rear edge of the exterior cover shell 22 and the interior cover shell 24 of the cover body 2 (as shown in FIG. 1). Thus, the cover body 2 is rotatable around the first second axle 54 of the second hinge assembly 50.

Now referring back to FIG. 1, when installing the hinge assembly 3, firstly, each of the first and second hinge subassemblies 40, 50 is separately assembled. The first and second hinge subassemblies 40, 50 are coaxially aligned, with the first and second joint axles 44, 54 being coaxially aligned accordingly. The first and second hinge subassemblies 40, 50 are secured to the main body 1 of the media player 100 via the first and second mounting holes 423, 523 of the first and second base plates 42, 52 and several screw bolts (not labeled). Then, the first hinge 40 is also secured to the lid body 2 of the media player 100 via the fixing holes 463 of the first hinge arm 46 and a pair of screw bolts (not shown).

When the cover body 2 of the media player 100 is opened up by a user, because the gravitational force acting on the cover body 2 is overcome by the friction force applied to the first hinge arm 46 of the hinge assembly 3, the cover body 2 can thus be retained at any desired position.

Conveniently, the friction force applied to the first hinge arm 46 can be adjusted by adjusting the degree of fastening tightness of the nut 406. In addition, the friction force applied to the first hinge arm 46 can also be adjusted by increasing the number of resilient bushings 404. In other exemplary embodiments, two or more resilient bushings may be arranged on the first joint axle 44 in a face to face or back to back manner relative to each other. The inventive hinge assembly 3 is universally applicable for various media players which have cover bodies of different weights.

It should be emphasized that the above-described embodiments of the present invention, including any preferred embodiments, are merely possible examples of implementation of the principles of the invention, and are merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and be protected by the following claims.

What is claimed is:

1. A hinge assembly for use in a media player having a main body and a cover, the hinge assembly comprising a first hinge subassembly, the first hinge subassembly comprising:
a first base plate adapted to be secured to the main body of the media player;
a first joint axle secured to the first base plate;
a first hinge arm adapted to be secured to the cover of the media player, the first hinge arm having a first end pivotally coupled to the first joint axle;
at least one resilient bushing surrounding the first joint axle, and arranged adjacent the first end of the first hinge arm; and
an adjustable fastener coupled to the first joint axle for exerting an adjustable force applied to the first end of the first hinge arm, so as to generate a friction force between the first end of the first hinge arm and the at least one resilient bushing, the friction force sufficient to overcome gravitational force acting on the cover of the media player.

2. The hinge assembly according to claim 1, wherein the first hinge subassembly further comprises at least one plain washer coupled to the first joint axle and arranged adjacent the first hinge arm.

3. The hinge assembly according to claim 2, wherein the at least one plain washer is unrotatable relative to the first joint axle.

4. The hinge assembly according to claim 3, wherein the adjustable fastener comprises a nut, which is in threaded engagement with the first joint axle.

5. The hinge assembly according to claim 4, further comprising a second hinge subassembly, the second hinge subassembly comprising a second base plate secured to the main body of the media player and a second joint axle secured to the second base plate.

6. The hinge assembly according to claim 5, wherein the first and second hinge subassemblies are aligned coaxially.

7. The hinge assembly according to claim 6, wherein the first and second joint axles are secured to the first and second base plates by rivets, respectively.

8. A media player, comprising:
a main body;
a cover body;
a hinge assembly for pivotally connecting the cover body to the main body, the hinge assembly comprising a first hinge subassembly, the first hinge subassembly comprising:
a first base plate adapted to be secured to the main body of the media player;
a first joint axle secured to the first base plate;
a first hinge arm adapted to be secured to the cover of the media player, the first hinge arm having a first end pivotally coupled to the first joint axle;
at least one resilient bushing surrounding the first joint axle, and arranged adjacent the first end of the first hinge arm; and
an adjustable fastener coupled to the first joint axle adapted for exerting an adjustable force applied to the first end of the first hinge arm, so as to generate a friction force between the first end of the first hinge arm and the at least one resilient bushing, the friction force sufficient to overcome gravitational force acting on the cover body.

9. The media player according to claim 8, wherein the first hinge further comprises at least one plain washer coupled to the first joint axle.

10. The media player according to claim 9, wherein the plain washer is unrotatable relative to the first joint axle.

11. The media player according to claim 10, wherein the hinge assembly further comprises a second hinge subassembly, the second hinge subassembly comprising a second base plate secured to the main body and a second joint axle secured to the second base plate.

12. The media player according to claim 11, wherein the first and second joint axles are secured to the first and second base plates by rivets, respectively.

13. A media player, comprising:
a main body;
a cover body releasable with respect to the main body; and
a hinge assembly pivotally connecting the cover body and the main body, the hinge assembly comprising a first hinge subassembly and a second hinge subassembly, the first hinge subassembly comprising:
a first base plate secured to the main body;
a first joint axle connected to the first base plate, a portion of the first joint axle being received in the cover body;
a first hinge arm secured to the cover body, and pivotally coupled to the first joint axle; and
at least one plain washer unrotatably sleeved on the first joint axle, and arranged adjacently to the first hinge arm; and
at least one resilient bushing sleeved on the first joint axle, and arranged adjacently to the at least one plain washer;
the second hinge subassembly comprising:
a second base plate secured to the main body of the media player; and
a second joint axle connected to the first base plate and coaxial with the first joint axle, a portion of the second joint axle being received in the cover body.

14. A media player according to claim 13, wherein the first joint axle and the second joint axle are respectively riveted to the first base plate and the second base plate.

15. A media player according to claim 14, wherein two first opposite flat faces are provided on the first hinge axle, and one of the two first opposite flat faces abuts against a side surface of the first base plate.

16. A media player according to claim 13, wherein the first hinge arm, the at least one plain washer, and the at least one resilient bushing are sleeved on a axle portion with a smaller diameter than the other portion of the first hinge axle, and the axle portion has two opposite flat side surfaces.

17. A media player according to claim 16, wherein the at least one plain washer defines a central hole with a similar profile to the axle portion of the first hinge axle.

18. A media player according to claim 13, wherein a fastener is coupled to the first joint axle, and is adjacent to one of the at least one plain washer and the at least one resilient bushing, adapted for exerting an adjustable force applied to said one of the at least one plain washer and the at least one resilient bushing, so as to generate a friction force between the first hinge arm and the at least one plain washer to overcome gravitational force acting on the first hinge arm.

19. A media player according to claim 18, wherein the fastener is a nut with internal thread, and the nut is threaded to a thread potion at distal end of the axle potion of the first hinge axle.

20. A media player according to claim 13, wherein the first base plate and the second base plate are screwed to the main body, and the first hinge arm is screwed to the cover body.
